(19) United States
(12) Patent Application Publication
(10) Pub. No.: US 2024/0256022 A1
(43) Pub. Date: Aug. 1, 2024

(54) CONTROL METHOD, APPARATUS, ELECTRONIC DEVICE AND STORAGE MEDIUM

(71) Applicant: Lenovo (Beijing) Limited, Beijing (CN)

(72) Inventors: Haotian YUAN, Beijing (CN); Xueli BAN, Beijing (CN); Zhengcao JIN, Beijing (CN)

(21) Appl. No.: 18/425,396

(22) Filed: Jan. 29, 2024

(30) Foreign Application Priority Data
Jan. 30, 2023 (CN) 202310103755.3

(51) Int. Cl. G06F 1/26

(52) U.S. Cl. CPC G06F 1/26

(57) ABSTRACT

A control method includes: acquiring first-type operation data of at least one target component in an electronic device, and response information of the electronic device to an interactive operation; and adjusting a power control parameter of the electronic device at least based on the first-type operation data and the response information, the power control parameter being used to control operating power consumption of the electronic device.

### CROSS-REFERENCE TO RELATED APPLICATION

This application claims priority to Chinese Patent Application No. 202310103755.3, filed on Jan. 30, 2023, and the entire content of which is incorporated herein by reference.

### TECHNICAL FIELD

The present disclosure relates to the technical field of electronic control technology, and more particularly, to a control method, a control apparatus, an electronic device, and a storage medium.

### BACKGROUND

Currently, in order to ensure that an application program runs smoothly, a processor in an electronic device runs at a high operating power when the application program is running. Especially when the application program is just started, the processor performs a turbo acceleration (e.g., turbo boost). This mechanism ensures that the application program does not freeze when running. However, due to its poor control intelligence, the processor executing the application program may consume more power than what the application program actually needs either when the application program is just started or during the operation after the startup, which causes elevated power consumption of the electronic device.

Therefore, how to improve the control intelligence of the electronic device has become an urgent technical problem to be solved.

### SUMMARY

One aspect of the present disclosure provides a control method. The control method includes: acquiring first-type operation data of at least one target component in an electronic device, and response information of the electronic device to an interactive operation; and adjusting a power control parameter of the electronic device at least based on the first-type operation data and the response information, the power control parameter being used to control operating power consumption of the electronic device.

Another aspect of the present disclosure provides an electronic device. The electronic device includes: a memory for storing a program; and a processor for calling and executing the program stored in the memory. When being executed by the processor, the program causes the processor to: acquire first-type operation data of at least one target component in an electronic device, and response information of the electronic device to an interactive operation; and adjust a power control parameter of the electronic device at least based on the first-type operation data and the response information, the power control parameter being used to control operating power consumption of the electronic device.

Another aspect of the present disclosure provides a non-transitory computer-readable storage medium storing a computer program. When being executed by a processor, the computer program causes the processor to: acquire first-type operation data of at least one target component in an electronic device, and response information of the electronic device to an interactive operation; and adjust a power control parameter of the electronic device at least based on the first-type operation data and the response information, the power control parameter being used to control operating power consumption of the electronic device.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of an exemplary control method according to some embodiments of the present disclosure;

FIG. 2 is a flowchart of determining a matching operation mode of an electronic device at least based on first-type operation data and response information, and obtaining a power control parameter corresponding to the operation mode according to some embodiments of the present disclosure;

FIG. 3 is a flowchart of adjusting the power control parameter of the electronic device based on the first-type operation data and the response information according to some embodiments of the present disclosure;

FIG. 4 is a schematic structural diagram of an exemplary control method according to some embodiments of the present disclosure;

FIG. 5 is a schematic structural diagram of an exemplary control apparatus according to some embodiments of the present disclosure; and

FIG. 6 is a schematic structural diagram of an exemplary electronic device according to some embodiments of the present disclosure.

### DETAILED DESCRIPTION OF THE EMBODIMENTS

The terms “first”, “second”, “third”, “fourth”, etc. (if present) in the description, claims, and drawings are used to distinguish similar parts and are not necessarily used to describe specific order or sequence. It is to be understood that data so used are interchangeable under certain circumstances such that the embodiments of the present disclosure described herein can be practiced in other sequences than illustrated herein.

The technical solutions in the embodiments of the present disclosure will be clearly and completely described below with reference to the accompanying drawings in the embodiments of the present disclosure. Obviously, the described embodiments are merely some of the embodiments of the present disclosure, rather than all of the embodiments. Based on the embodiments in the present disclosure, all other embodiments obtained by those of ordinary skill in the art without creative efforts fall within the scope of protection of the present disclosure.

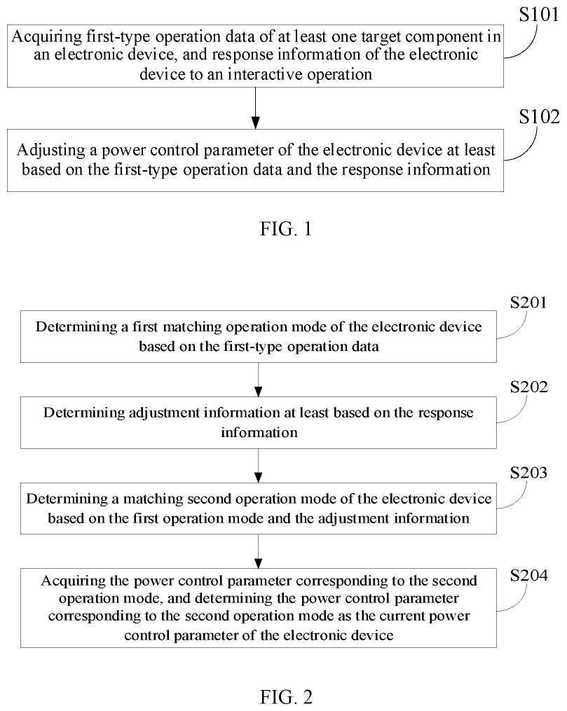

The present disclosure provides a control method and a control apparatus that can be used in an electronic device, such as a desktop computer, a laptop computer, a tablet computer, a mobile phone, and other suitable devices. FIG. 1 is a flowchart of an exemplary control method according to some embodiments of the present disclosure. As shown in FIG. 1, the control method includes the following processes.

At S101, first-type operation data of at least one target component in an electronic device, and response information of the electronic device to an interactive operation are acquired.

In some embodiments, the at least one target component may include but is not limited to at least one of the following components: a central processing unit (CPU), a graphics processing unit (GPU), a solid-state drive (SSD), and a memory, etc.

In some embodiments, the first-type operation data may be acquired through sensors. For example, the first-type operation data may be load data, including but not limited to: a voltage, a current, and a power. The response information of the electronic device to the interactive operation of the operator may include, but is not limited to: the response information of a foreground application of the electronic device to the interactive operation of the operator. For example, the response information may include but is not limited to: a response time of the foreground application to the interactive operation of the operator, and a switching time of the foreground application, etc.

At S102, a power control parameter of the electronic device is adjusted at least based on the first-type operation data and the response information. The power control parameter is used to control operating power consumption of the electronic device.

In some embodiments, the power control parameter of the electronic device may include, but is not limited to: a power control parameter used to control operating power consumption of the CPU. The power control parameter used to control the operating power consumption of the CPU may include but is not limited to: a long-term operating power (power limit 1, PL1), a short-term turbo power (power limit 2, PL2), and a duration of the short-term turbo power (TAU).

The long-term operating power PL1 represents a maximum power that the CPU may consume during normal operation. The short-term turbo power PL2 represents a maximum power that the CPU may consume during a turbo operation. PL2 is greater than PL1.

A maximum operating power consumption of the CPU is positively correlated to the long-term operating power. The maximum operating power consumption of the CPU is positively correlated to the short-term turbo power. The maximum operating power consumption of the CPU is positively correlated to the duration of the short-term turbo power.

In some embodiments, the power control parameter in this specification may also be a power control parameter that controls the operating power consumption of another component (such as fans, SSDs, etc.).

The first-type operation data and the response information are data that can be acquired in real time during the operation of the electronic device. Therefore, the power parameter of the electronic device may be adjusted in real time based on the first-type operation data and the response information.

In the control method provided by the embodiments of the present disclosure, at least based on the first-type operation data of the at least one target component in the electronic device and the response information of the electronic device to the interactive operation of the operator, the power control parameter used to control the operating power consumption of the electronic device is adjusted. The power control parameter of the electronic device is adjusted intelligently and an intelligent control of the electronic device is improved. Thus, the operating power consumption of the electronic device can be intelligently controlled.

In some embodiments, adjusting the power control parameter of the electronic device at least based on the first-type operation data and the response information may include: at least based on the first-type operation data and the response information, determining a matching operation mode of the electronic device, and obtaining a power control parameter corresponding to the operation mode to be the current power control parameter of the electronic device.

FIG. 2 is a flowchart of determining a matching operation mode of an electronic device at least based on first-type operation data and response information, and obtaining a power control parameter corresponding to the operation mode according to some embodiments of the present disclosure. As shown in FIG. 2, the flowchart includes the following processes.

At S201, a first matching operation mode of the electronic device is determined based on the first-type operation data.

In some embodiments, the first-type operation data may be processed through a pre-trained first prediction model to determine the first-type operation mode of the electronic device that matches the first-type operation data.

In the embodiments of the present disclosure, the power control parameter of the electronic device may include a plurality of power control parameters. The operation mode of the electronic device may be divided into multiple operation modes in advance. Different operation modes correspond to different power control parameters. Under the control of the plurality of power control parameters corresponding to different operation modes, the maximum operating power consumption of electronic device may be different.

The first prediction model is trained by using the first-type operation data of the at least one target component as first training data, and using the operation mode of the electronic device matching the first-type operation data as a first label.

The first training data may be acquired in the following way: corresponding to an operation mode of the electronic device, controlling the electronic device to operate in the operation mode (e.g., operating such that the maximum operating power of the electronic device reaches a corresponding value of the power control parameter for the operation mode of at least one application program), acquiring the first-type operation data of the at least one target component in the operation mode, and marking the operation mode as the first training data (i.e., the acquired first-type operation data data) label (i.e. the first label).

The first prediction model may be any of the following networks: a recurrent neural network (RNN), a deep neural network (DNN), and a convolutional neural network (CNN), etc.

At S202, adjustment information is determined at least based on the response information. The adjustment information indicates whether the plurality of power control parameters of the electronic device needs to be adjusted.

For example, the plurality of power control parameters are PL1, PL2, and TAU of the CPU. Adjusting the power control parameters of the CPU includes: increasing at least one of PL1, PL2, and TAU of the CPU.

In some embodiments, the response information may be processed through a pre-trained second prediction model to determine the adjustment information.

The second prediction model is trained using the response information of the electronic device as second training data, and whether the electronic device corresponding to the response information needs to increase the power control parameter as a second label.

The second training data may be acquired in the following ways. The pre-trained first prediction model is deployed to the electronic device, and the electronic device is started. A data acquisition person may operate the electronic device such that the electronic device operates in an operation mode. During the operation of the electronic device in the operation mode, the first-type operation data of the at least one target component is acquired, and the response information of the electronic device to the interactive operation operated by an operator (e.g., the response information of the interactive operation of the data acquisition person's finger, or the mouse, stylus and other input devices operated by the data acquisition person). The first-type operation data are processed through the first prediction model to determine the matching operation mode of the electronic device and subsequently determine the power control parameter corresponding to the operation mode to control power consumption of the electronic device. If the data acquisition person feels that the electronic device is frozen during operation, the data acquisition person may operate a hot key of the electronic device. After the electronic device detects that the hot key is pressed, it will count the number of times when the hot key is pressed. When the number of times when the hot key is pressed reaches a target value, the power control parameter of the electronic device that needs to be increased is marked as the label (i.e., the second label) of the second training data (which at least contains the response information). While the electronic device is running in the operation mode, if the number of times when the hot key is pressed is smaller than the target value, the power control parameter of the electronic device that does not need to be increased is marked as the label of the second training data.

By training the first prediction model and the second prediction model separately, the present disclosure avoids the problem of data mutual interference that occurs when the first prediction model and the second prediction model are trained simultaneously.

At S203, a matching second operation mode of the electronic device is determined based on the first operation mode and the adjustment information. The second operation mode is different from the first operation mode, and different operation modes correspond to different power control parameters.

In some embodiments, the second operation mode of the electronic device that matches the first-type operation data and the response information is determined based on the first operation mode and the adjustment information.

If the adjustment information indicates that the power control parameter of the electronic device needs to be increased, when the matching second operation mode of the matching electronic device is determined, the power control parameter corresponding to the second operation mode is greater than the power control parameter corresponding to the first operation mode. The maximum operating power consumption of the electronic device under the power control parameter corresponding to the second operation mode is greater than the maximum operating power consumption of the electronic device under the power control parameter corresponding to the first operation mode.

If the adjustment information indicates that there is no need to increase the power control parameter of the electronic device, when the matching second operation mode of the electronic device is determined, the power control parameter corresponding to the second operation mode is smaller than the power control parameter corresponding to the first operation mode. The maximum operating power consumption of the electronic device under the power control parameter corresponding to the second operation mode is smaller than the maximum operating power consumption of the electronic device under the power control parameter corresponding to the first operation mode.

In some embodiments, the operation modes into which the plurality of power control parameters of the electronic device are divided include only operation modes of a same type. Therefore, the first operation mode and the second operation mode belong to the same type of operation modes.

In some embodiments, the operation modes into which the plurality of power control parameters of the electronic device are divided include first-type operation modes and second-type operation modes corresponding to the first-type operation modes. Different first-type operation modes correspond to same or different second-type operation modes. The maximum operating power consumption of the electronic device under the power control parameter corresponding to a second-type operation mode is greater than that of the electronic device under the power control parameter corresponding to a first-type operation mode corresponding to the second-type operation mode. The first operation mode belongs to the first-type operation modes. Based on this, if the adjustment information indicates that the power control parameter of the electronic device needs to be increased, the second-type operation mode corresponding to the first operation mode is determined as the matching second operation mode of the electronic device. At this time, the first operation mode and the second operation mode belong to different types of operation modes. If the adjustment information indicates that the power control parameter of the electronic device does not need to be increased, the matching second operation mode of the electronic device is determined in the first-type operation modes. At this time, the first operation mode and the second operation mode belong to a same type of operation modes.

In some embodiments, the operation modes into which the plurality of power control parameters of the electronic device are divided include the first-type operation modes, the second-type operation modes and third-type operation modes, which are corresponding to the first-type operation modes. Different first-type operation modes correspond to same or different second-type operation modes. The maximum operating power consumption of the electronic device under the power control parameter corresponding to the second-type operation mode is greater than that of the electronic device under the power control parameter corresponding to the first-type operation mode corresponding to the second-type operation mode. Different first-type operation modes correspond to same or different third-type operation modes. The maximum operating power consumption of the electronic device under the power control parameter corresponding to the third-type operation mode is smaller than that of the electronic device under the power control parameter corresponding to the first-type operation mode corresponding to the third-type operation mode. The first operation mode belongs to the first-type operation modes. Based on this, if the adjustment information indicates that the power control parameter of the electronic device needs to be increased, the second-type operation mode corresponding to the first-type operation mode is determined as the matching second operation mode of the electronic device. At this time, the first operation mode and the second operation mode belong to different types of operation modes. If the adjustment information indicates that there is no need to increase the power control parameter of the electronic device, the third-type operation mode corresponding to the first operation mode is determined as the matching second operation mode of the electronic device. At this time, the first operation mode and the second operation mode also belong to different types of operation modes.

At S204, the power control parameter corresponding to the second operation mode is acquired, and the power control parameter corresponding to the second operation mode is determined as the current power control parameter of the electronic device.

Further, after determining the power control parameter corresponding to the second operation mode as the current power control parameter of the electronic device, the operating power consumption of the electronic device can be controlled based on the power control parameter corresponding to the second operation mode.

Processing performance of the electronic device in the second operation mode is better than processing performance of the electronic device in the first operation mode. That is, the maximum operating power consumption of the electronic device under the power control parameter corresponding to the second operation mode is greater than that of the electronic device under the power control parameter corresponding to the first operation mode. If within a target duration, it is determined based on the first-type operation data of the at least one target component that the operation mode of the electronic device is still the first operation mode, the power control parameter of the electronic device is adjusted to the power control parameter corresponding to the first operation mode.

For example, the plurality of power control parameters of the electronic device include PL1, PL2, and TAU of the CPU. The target duration is smaller than a value of TAU in the power control parameter corresponding to the second operation mode.

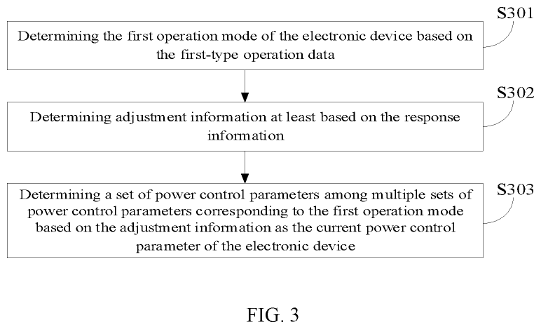

FIG. 3 is a flowchart of adjusting the power control parameter of the electronic device based on the first-type operation data and the response information according to some embodiments of the present disclosure. In some embodiments, as shown in FIG. 3, adjusting the power control parameter of the electronic device based on the first-type operation data and the response information includes the following processes.

At S301, the first operation mode of the electronic device is determined based on the first-type operation data. Each operation mode corresponds to multiple sets of power control parameters, and different operation modes correspond to at least one different set of power control parameters.

In some embodiments, the first-type operation data may be processed through the pre-trained first prediction model to determine the first operation mode of the electronic device that matches the first-type operation data.

In some embodiments, the plurality of power control parameters of the electronic device are divided into multiple operation modes in advance. Each operation mode corresponds to multiple sets of power control parameters, and different operation modes correspond to at least one set of different power control parameters. Among the multiple sets of power control parameters corresponding to each operation mode, the maximum operating power consumption of the electronic device is different under different sets of power control parameters.

The multiple sets of power control parameters include reference power control parameters and multiple sets of non-reference power control parameters. The reference power control parameters corresponding to different operation modes are different, and the non-reference power control parameters in a same operation mode are determined based on the reference power control parameters. Specifically, the first-type non-reference power control parameters in the same operation mode are obtained by decreasing the reference power control parameters, while the second-type non-reference power control parameters in the same operation mode is obtained by increasing the reference power control parameters. Thus, in a same operation mode, the maximum operating power consumption of the electronic device determined based on the non-reference power control parameters is smaller than the maximum operating power consumption of the electronic device determined based on the reference power control parameters, or, the maximum operating power consumption of the electronic device determined based on the non-reference power control parameters is greater than that of the electronic device determined based on the reference power control parameters

The first prediction model is trained by using the first-type operation data of the at least one target component as the first training data, and using the operation mode of the electronic device matching the first-type operation data as the first label.

The first training data may be acquired in the following way: corresponding to an operation mode of the electronic device, controlling the electronic device to operate in the operation mode (e.g., operating such that the maximum operating power of the electronic device reaches a corresponding value of the reference power control parameter for the operation mode of at least one application program), acquiring the first-type operation data of the at least one target component in the first operation mode, and marking the operation mode as the first training data (i.e., the acquired first-type operation data data) label (i.e. the first label).

The first prediction model may be any of the following networks: a recurrent neural network (RNN), a deep neural network (DNN), and a convolutional neural network (CNN), etc.

At S302, adjustment information is determined at least based on the response information.

In some embodiments, the response information may be processed through the pre-trained second prediction model to determine the adjustment information.

The second prediction model is trained using the response information of the electronic device as the second training data, and whether the electronic device corresponding to the response information needs to increase the power control parameter as the second label.

The second training data may be acquired in the following ways. The pre-trained first prediction model is deployed to the electronic device, and the electronic device is started. The data acquisition person may operate the electronic device such that the electronic device operates in an operation mode. During the operation of the electronic device in the operation mode, the first-type operation data of the at least one target component is acquired, and the response information of the electronic device to the interactive operation operated by the operator (e.g., the response information of the interactive operation of the data acquisition person's finger, or the mouse, stylus and other input devices operated by the data acquisition person). The first-type operation data are processed through the first prediction model to determine the matching operation mode of the electronic device, and subsequently determine the reference power control parameter corresponding to the operation mode to control the power consumption of the electronic device. If the data acquisition person feels that the electronic device is frozen during operation, the data acquisition person may operate the hot key of the electronic device. After the electronic device detects that the hot key is pressed, it will count the number of times when the hot key is pressed. When the number of times when the hot key is pressed reaches the target value, the power control parameter of the electronic device that needs to be increased is marked as the label (i.e., the second label) of the second training data (which at least contains the response information). While the electronic device is running in the operation mode, if the number of times when the hot key is pressed is smaller than the target value, the power control parameter of the electronic device that does not need to be increased is marked as the label of the second training data.

The adjustment information indicates whether the power control parameter of the electronic device needs to be increased.

At S303, a set of power control parameters among multiple sets of power control parameters corresponding to the first operation mode is determined based on the adjustment information as the current power control parameter of the electronic device.

In some embodiments, the multiple sets of power control parameters include the reference power control parameters and the multiple sets of non-reference power control parameters. Based on the adjustment information and the reference power control parameters corresponding to the first operation mode, the set of power control parameters may be determined among the multiple sets of the non-reference power parameters corresponding to the first operation mode as the current power control parameter of the electronic device.

If the adjustment information indicates that there is no need to increase the power control parameter of the electronic device, a first power control parameter is determined among the multiple sets of the non-reference power control parameters corresponding to the first operation mode as the current power control parameter of the electronic device. In some embodiments, a difference between the operating power consumption of the electronic device under the reference power control parameter and the operating power consumption of the electronic device under the first power control parameter is negatively related to the operating power consumption of the electronic device under the reference power control parameter. That is, when the power control parameter of the electronic device is decreased, the greater the operating power consumption of the electronic device under the reference power control parameter, the smaller the difference between the operating power consumption of the electronic device under the reference power control parameter and the operating power consumption of the electronic device under the first power control parameter.

If the adjustment information indicates that the power control parameter of the electronic device needs to be increased, a second power control parameter is determined among the multiple sets of the non-reference power control parameters corresponding to the first operation mode as the current power control parameter of the electronic device. In some embodiments, the difference between the operating power consumption of the electronic device under the second power control parameter and the operating power consumption of the electronic device under the reference power control parameters is positively related to the operating power consumption of the electronic device under the reference power control parameter. That is, when the power control parameter of the electronic device is increased, the greater the operating power consumption of the electronic device under the reference power control parameter, the greater the difference between the operating power consumption of the electronic device under the second power control parameter and the operating power consumption of the electronic device under the reference power control parameter.

The first power control parameter belongs to the first-type non-reference power control parameters, and the second power control parameter belongs to the second-type non-reference power control parameters. Therefore, the maximum operating power consumption of the electronic device under the first power control parameter is smaller than the maximum operating power consumption of the electronic device under the reference power control parameter, and the maximum operating power consumption of the electronic device under the second power control parameter is greater than the maximum operating power consumption of the electronic equipment under the reference power control parameter.

In some embodiments, the control method may further include: obtaining the second-type operation data of the target component. For example, the second-type operation data may be an occupancy rate of the target component, such as a CPU occupancy rate, a GPU occupancy rate, a SSD occupancy rate, and a memory occupancy rate, etc.

In some embodiments, determining the adjustment information based on the response information may include: determining the adjustment information based on the second-type operation data and the response information.

In some embodiments, the second-type operation data and the response information may be processed through the pre-trained second prediction model to determine the adjustment information.

The second prediction model is trained using the second-type operation data and the response information as the second training data, and using whether the electronic device corresponding to the second-type operation data and the response information needs to increase the power control parameter as the second label.

The second training data may be acquired in the following ways. The pre-trained first prediction model is deployed to the electronic device, and the electronic device is started. The data acquisition person may operate the electronic device such that the electronic device operates in an operation mode. During the operation of the electronic device in the operation mode, the first-type operation data and the second-type operation data of the at least one target component are acquired, and the response information of the electronic device to the interactive operation operated by the operator (e.g., the response information of the interactive operation of the data acquisition person's finger, or the mouse, stylus and other input devices operated by the data acquisition person). The first-type operation data are processed through the first prediction model to determine the matching operation mode of the electronic device, and subsequently determine the power control parameter corresponding to the determined operation mode to control the power consumption of the electronic device (in the case where one operation mode corresponds to multiple power control parameters, it is the reference power control parameter). If the data acquisition person feels that the electronic device is frozen during operation, the data acquisition person may operate the hot key of the electronic device. After the electronic device detects that the hot key is pressed, it will count the number of times when the hot key is pressed. When the number of times when the hot key is pressed reaches the target value, the power control parameter of the electronic device that needs to be increased is marked as the label (i.e., the second label) of the second training data (which at least contains the second-type operation data and the response information). While the electronic device is running in the operation mode, if the number of times when the hot key is pressed is smaller than the target value, the power control parameter of the electronic device that does not need to be increased is marked as the label of the second training data.

The embodiments of the present disclosure is described below by taking adjusting the power control parameters of the CPU as an example. In this example, the power control parameters include: PL1, PL2 and TAU, where the units of PL1 and PL2 are watts and the unit of TAU is seconds. This example divides the power control parameters into 8 operation modes, as shown in Table 1, which is an example of the 8 operation modes provided in this example.

TABLE 1

| Operation mode | PL1(W) | PL2(W) | TAU(second) |
|---|---|---|---|
| 0 | 7 | 25 | 10 |
| 1 | 9 | 25 | 10 |
| 2 | 12 | 25 | 10 |
| 3 | 15 | 30 | 10 |
| 4 | 20 | 35 | 28 |
| 5 | 25 | 40 | 28 |
| 6 | 30 | 50 | 28 |
| 7 | 35 | 64 | 56 |

This example sets up power sensors for the CPU, the GPU, the SSD, and the memory respectively to acquire the first-type operation data (current, voltage, and power) of the CPU, the first-type operation data of the GPU, the first-type operation data of the SSD. and the first-type operation data of the memory.

For the CPU, the CPU occupancy rate is also acquired through the operating system.

For foreground applications, the response information of the foreground applications acquired through the operating system include: the response time or the switching time of the foreground applications.

The process of acquiring the second training data includes the following findings. When the operation mode determined based on the first-type operation data is between 0 and 2, but the CPU occupancy rate is higher than 15%, the adjustment information determined based on the CPU occupancy rate and the response information of the foreground application is often to increase the power control parameter of the CPU.

When the operation mode determined based on the first-type operation data is between 0 and 2, but the response time of the foreground application is greater than 80 ms, the adjustment information determined based on the CPU occupancy rate and the response information of the foreground application is often to increase the power control parameter of the CPU.

When the CPU turbo acceleration is performed and the operation mode determined based on the first-type operation data is still between 0 and 2 within 400 ms, the CPU will exit the turbo acceleration and apply the power control parameter corresponding to the latest operation mode determined based on the first-type operation data.

Based on the above findings, the present disclosure sets a turbo operation mode for the operation modes 0˜3 in Table 1, which is shown as Turbo Mode. As shown in Table 2, it is an example of the Turbo Mode provided by the present disclosure.

TABLE 2

| Operation mode | PL1(W) | PL2(W) | Turbo Time |
|---|---|---|---|
| Turbo Mode | 18 | 32 | 600 ms |

The Turbo Mode shown in Table 2 will be triggered when the adjustment information determined based on the CPU occupancy rate and the response information of the foreground application requires increasing the power control parameter of the CPU.

The process of determining the operation mode based on the first-type operation data, and the process of determining the adjustment information based on the CPU occupancy rate and the response information of the foreground application may be performed through the first prediction model and the second prediction model that are integrated in an AI chip (i.e., artificial intelligence chip).

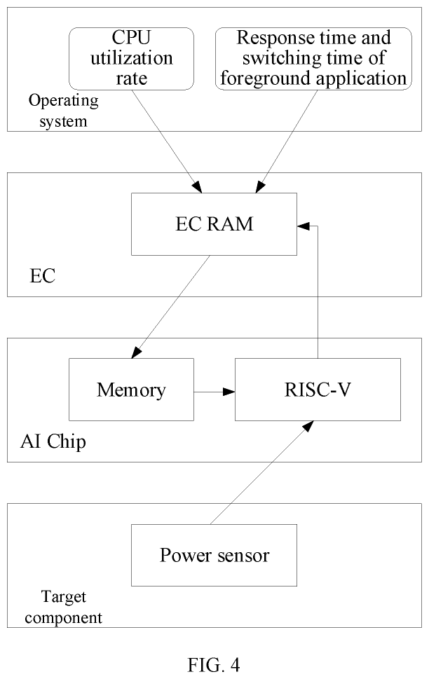

FIG. 4 is a schematic structural diagram of an exemplary control method according to some embodiments of the present disclosure. During the operation of the electronic device, the operating system (OS) obtains the CPU occupancy rate and the response information of the foreground application (i.e., the response time or the switching time of the foreground application), and then uses an embedded controller (EC) to interact with the AI Chip for data. Specifically, the operating system may send the CPU occupancy rate and the response information of the foreground application to the AI Chip through the RAM memory of the EC. The data exchange protocol between the operating system and the EC, and the data exchange protocol between the EC and the AI Chip may all be I2C protocol. Since the power consumption of the EC is reduced when in operation, using the EC to exchange the data between the operating system and the AI Chip ensures that a data transmission process is performed at low power consumption.

Each power sensor reports the acquired first-type operation data to the AI Chip.

As a data processing center, the AI Chip predicts the operation mode of the CPU based on the first-type operation data reported by each power sensor, predicts the adjustment information based on the response time and the switching time of the foreground application reported by the operating system, and combine the operation mode and the adjustment information to send by EC to BIOS for adjusting the power control parameter of the CPU.

In one example, if the operation mode is Mode 1 and the adjustment information indicates that the power control parameter of the CPU needs to be increased, the BIOS can adjust the power control parameter of the CPU to the power control parameter corresponding to Turbo Mode shown in Table 2. If the operation mode is Mode 1 and the adjustment information indicates that there is no need to increase the power control parameter of the CPU, the BIOS can adjust the power control parameter of the CPU to the power control parameter corresponding to Mode 0.

In another example, if the operation mode is Mode 3 and the adjustment information indicates that the power control parameter of the CPU needs to be increased, BIOS can adjust the power control parameter of the CPU to the power control parameter corresponding to Turbo Mode shown in Table 2. If the operation mode is Mode 3 and the adjustment information indicates that there is no need to increase the power control parameter of the CPU, BIOS can adjust the power control parameter of the CPU to the power control parameter corresponding to Mode 2 or Mode 1.

In another example, after adjusting the power control parameter of the CPU to the power control parameter corresponding to Turbo Mode shown in Table 2, the CPU adjusts the operating power consumption of the electronic device based on the power control parameter corresponding to Turbo Mode. If the AI Chip predicts within 400 ms that the CPU's operation mode is still Mode 3 based on the first-type operation data reported by each power sensor, the CPU exits Turbo Mode and determines the power control parameter corresponding to Mode 3 as the current power control parameter of the electronic device.

The AI Chip may have a RISC-V architecture and a deep learning acceleration engine to ensure that algorithm calculation consumption is negligible.

In the above example, only some modes correspond to Turbo Mode. In some embodiments, all eight modes may correspond to Turbo Mode, but some modes correspond to different Turbo modes. For example, modes 0 to 3 correspond to the Turbo Mode shown in Table 2, and modes 4 to 7 correspond to Turbo mode shown in Table 3.

TABLE 3

| Operation mode | PL1(W) | PL2(W) | Turbo Time |
|---|---|---|---|
| Turbo Mode | 38 | 65 | 700 ms |

By setting different Turbo modes, battery life can be effectively improved, and fast response of the electronic device is ensured.

In another example, different modes correspond to different Turbo modes. In this way, it may also effectively improve the battery life and ensure rapid response of electronic devices.

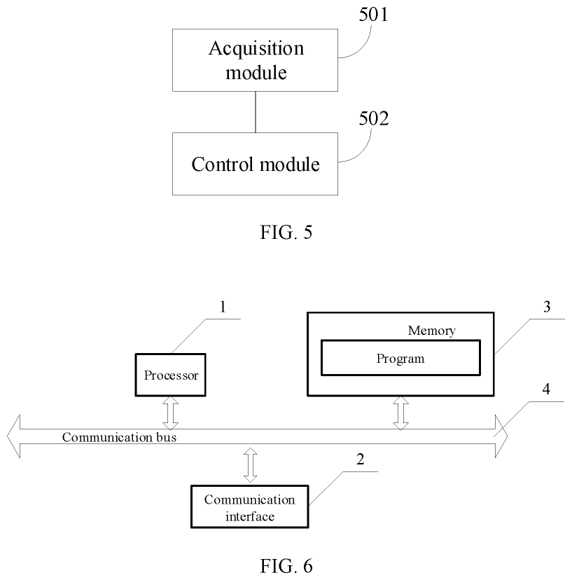

Corresponding to the control method, the present disclosure also provides a control apparatus. FIG. 5 is a schematic structural diagram of an exemplary control apparatus according to some embodiments of the present disclosure. As shown in FIG. 5, the control apparatus includes: an acquisition module 501 and a control module 502. The acquisition module 501 is configured to acquire the first-type operation data of the at least one target component in the electronic device, and the response information of the electronic device to the interactive operation operated by the operator. The control module 502 is configured to adjust the power control parameter of the electronic device at least based on the first-type operation data and the response information. The power control parameters are used to control the operating power consumption of the electronic device.

In the embodiments of the present disclosure, at least based on the first-type operation data of the at least one target component in the electronic device and the response information of the electronic device to the interactive operation operated by the operator, the control apparatus adjusts the power control parameters to control the operating power consumption of the electronic device. Thus, the power control parameters of the electronic equipment can be intelligently adjusted, the electronic device can be intelligently controlled, and the operating power consumption of the electronic equipment can be intelligently controlled.

In some embodiments, the control module 502 is configured to: at least based on the first-type operation data and the response information, determine the matching operation mode of the electronic device, and obtain the power control parameter corresponding to the operation mode as the current power control parameter of the electronic device.

In some embodiments, the control module 502 is configured to: determine the matching first operation mode of the electronic device based on the first-type operation data; determine the adjustment information at least based on the response information, where the adjustment information indicates whether the power control parameter of the electronic device needs to be increased; determine the matching second operation mode of the electronic device based on the first operation mode and the adjustment information; and obtain the power control parameter corresponding to the second operation mode, and use the power control parameter corresponding to the second operation mode as the current power control parameter of the electronic device. Different operation modes correspond to different power control parameters.

In some embodiments, the control module 502 is configured to: determine the first operation mode of the electronic device based on the first-type operation data, where each operation mode corresponds to multiple sets of power control parameters, and different operation modes correspond to at least one set of different power control parameters; determine the adjustment information at least based on the response information, where the adjustment information indicates whether the power control parameter of the electronic device needs to be increased; based on the adjustment information, determine a set of power control parameters among the multiple sets of power control parameters corresponding to the first operation mode as the current power control parameters of the electronic device.

In some embodiments, when determining the adjustment information at least based on the response information, the control module 502 is configured to: obtain the second-type operation data of the target component; and determine the adjustment information based on the second-type operation data and the response information.

In some embodiments, when determining the set of power control parameters among the multiple sets of power control parameters corresponding to the first operation mode based on the adjustment information as the current power control parameters of the electronic device, the control module 502 is further configured to: if the adjustment information indicates that there is no need to increase the power control parameters of the processor, determine the first power control parameter among the multiple sets of non-reference power control parameters corresponding to the first operation mode as the current power control parameter of the electronic device; and if the adjustment information indicates that the power control parameters of the processor need to be increased, determine the second power control parameter among the multiple sets of non-reference power control parameters corresponding to the first operation mode as the current power control parameter of the electronic device.

The maximum operating power consumption of the electronic device under the first power control parameter is smaller than the maximum operating power consumption of the electronic device under the reference power control parameter, and the maximum operating power consumption of the electronic device under the second power control parameter is greater than the maximum operating power consumption of the electronic device under the reference power control parameter.

In some embodiments, the control module 502 is further configured to: control the operating power consumption of the electronic device based on the power control parameters corresponding to the second operation mode; and if it is determined within the target duration that the operation mode of the electronic device is the first operation mode based on the first-type operation data of the at least one target component, adjust the power control parameter of the electronic device to the power control parameter corresponding to the first operation mode.

The processing performance of the electronic device in the second operation mode is better than the processing performance of the electronic device in the first operation mode.

Corresponding to the control method, the present disclosure also provides an electronic device. FIG. 6 is a schematic structural diagram of an exemplary electronic device according to some embodiments of the present disclosure. As shown in FIG. 6, the electronic device includes: at least one processor 1, at least one communication interface 2, at least one memory 3, and at least one communication bus 4.

In some embodiments, the number of the at least one processor 1, the at least one communication interface 2, the at least one memory 3, and the at least one communication bus 4 is at least one. The at least one processor 1, the at least one communication interface 2, and the at least one memory 3 communicate with each other through the at least one communication bus 4.

The at least one processor 1 may be a central processing unit (CPU), an application specific integrated circuit (ASIC), or one or more integrated circuits configured to implement the embodiments of the present disclosure.

The at least one memory 3 may include a high-speed RAM memory, and may also include a non-volatile memory, such as at least one disk memory.

The at least one memory 3 stores a program, and the processor 1 can call the program stored in the memory 3. The program is configured to: obtain the first-type operation data of the at least one target component in the electronic device, and the response information of the electronic device to the interactive operation operated by the operator; and at least based on the first-type operation data and the response information, adjust the power control parameters of the electronic device. The power control parameters are used to control the operating power consumption of the electronic device.

For detail functions and extended functions of the program, reference can be made to the description of the control method.

The present disclosure also provides a storage medium, which stores a program suitable for execution by a processor. The program is configured to: obtain the first-type operation data of the at least one target component in the electronic device, and the response information of the electronic device to the interactive operation operated by the operator; and at least based on the first-type operation data and the response information, adjust the power control parameters of the electronic device. The power control parameters are used to control the operating power consumption of the electronic device.

For detail functions and extended functions of the program, reference can be made to the description of the control method.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered beyond the scope of the present disclosure.

In the embodiments of the present disclosure, it should be understood that the disclosed electronic device, control apparatus and control method may be implemented in other ways. On the other hand, the coupling or direct coupling or communication connection between each other shown or discussed may be through some interfaces, and the indirect coupling or communication connection of the devices or units may be in electrical, mechanical or other forms.

The units described as separate components may or may not be physically separated, and the components shown as units may or may not be physical units, that is, they may be located in one place, or they may be distributed to multiple network units. Some or all of the units may be selected according to actual needs to achieve the objective of the technical solution of the present disclosure.

In addition, each functional unit in each embodiment of the present disclosure may be integrated into one processing unit. Each unit may exist physically alone, or two or more units may be integrated into one unit.

It should be understood that in the embodiments of the present disclosure, claims, various embodiments, and features may be combined with each other to solve the aforementioned technical problems.

If the functions are implemented in the form of software functional units and sold or used as independent products, they may be stored in a computer-readable storage medium. Based on this understanding, the technical solution of the present disclosure or the part that contributes to the existing technology or the part of the technical solution can be embodied in the form of a software product. The computer software product stored in the storage medium includes a plurality of instructions used to cause a computer device (which may be a personal computer, a server, or a network device, etc.) to execute all or part of the steps of the methods described in various embodiments of the present disclosure. The aforementioned storage medium includes: a U disk, a mobile hard disk, a read-only memory (ROM), a random-access memory (RAM), a magnetic disk or an optical disk, and other media suitable for storing program codes.

The above description of the disclosed embodiments enables those skilled in the art to implement or use the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments shown herein but is to be accorded the broadest scope consistent with the principles and novel features disclosed herein.

What is claimed is:

1. A control method, comprising:
acquiring first-type operation data of at least one target component in an electronic device, and response information of the electronic device to an interactive operation; and
adjusting a power control parameter of the electronic device at least based on the first-type operation data and the response information, the power control parameter being used to control operating power consumption of the electronic device.

2. The control method according to claim 1, wherein adjusting the power control parameter of the electronic device at least based on the first-type operation data and the response information comprises:
at least based on the first-type operation data and the response information, determining a matching operation mode of the electronic device, and obtaining the power control parameter corresponding to the operation mode as a current power control parameter of the electronic device.

3. The control method according to claim 2, wherein determining the matching operation mode of the electronic device, and obtaining the power control parameter corresponding to the operation mode as the current power control parameter of the electronic device at least based on the first-type operation data and the response information comprises:
determining a matching first operation mode of the electronic device based on the first-type operation data;
determining adjustment information at least based on the response information, the adjustment information indicating whether the power control parameter of the electronic device need to be increased;
determining a matching second operation mode of the electronic device based on the first operation mode and the adjustment information; and
acquiring the power control parameter corresponding to the second operation mode, and determining the power control parameter corresponding to the second operation mode to be the current power control parameter of the electronic device, different operation modes corresponding to different power control parameters.

4. The control method according to claim 1, wherein adjusting the power control parameter of the electronic device at least based on the first-type operation data and the response information comprises:
determining the first operation mode of the electronic device based on the first-type operation data, each operation mode corresponding to multiple sets of power control parameters, and different operation mode corresponding to at least one set of different power control parameters;
determining adjustment information at least based on the response information, the adjustment information indicating whether the power control parameter of the electronic device need to be increased; and
based on the adjustment information, determining a set of power control parameters among the multiple sets of power control parameters as the current power control parameter of the electronic device.

5. The control method according to claim 3, wherein determining the adjustment information at least based on the response information comprises:
acquiring second-type operation data of the at least one target component; and
based on the second-type operation data and the response information, determining the adjustment information.

6. The control method according to claim 4, wherein determining the set of power control parameters among the multiple sets of power control parameters as the current power control parameter of the electronic device based on the adjustment information comprises:
if the adjustment information indicates that there is no need to increase the power control parameters of a processor, determining the first power control parameter among the multiple sets of non-reference power control parameters corresponding to the first operation mode as the current power control parameter of the electronic device;
if the adjustment information indicates that the power control parameters of the processor need to be increased, determining the second power control parameter among the multiple sets of non-reference power control parameters corresponding to the first operation mode as the current power control parameter of the electronic device;
wherein a maximum operating power consumption of the electronic device under the first power control parameter is smaller than a maximum operating power consumption of the electronic device under the reference power control parameter, and a maximum operating power consumption of the electronic device under the second power control parameter is greater than the maximum operating power consumption of the electronic device under the reference power control parameter.

7. The control method according to claim 3, further comprising:
controlling the operating power consumption of the electronic device based on the power control parameter corresponding to the second operation mode; and
if it is determined within a target duration that the operation mode of the electronic device is the first operation mode based on the first-type operation data of the at least one target component, adjusting the power control parameter of the electronic device to the power control parameter corresponding to the first operation mode;
wherein processing performance of the electronic device in the second operation mode is better than processing performance of the electronic device in the first operation mode.

8. An electronic device, comprising:
a memory for storing a program; and
a processor for calling and executing the program stored in the memory, when being executed by the processor, the program causing the processor to:
acquire first-type operation data of at least one target component in an electronic device, and response information of the electronic device to an interactive operation; and
adjust a power control parameter of the electronic device at least based on the first-type operation data and the response information, the power control parameter being used to control operating power consumption of the electronic device.

9. The electronic device according to claim 8, wherein when adjusting the power control parameter of the electronic device at least based on the first-type operation data and the response information, the processor is further configured to:
at least based on the first-type operation data and the response information, determine a matching operation mode of the electronic device, and obtain the power control parameter corresponding to the operation mode as a current power control parameter of the electronic device.

10. The electronic device according to claim 9, wherein when determining the matching operation mode of the electronic device, and obtaining the power control parameter corresponding to the operation mode as the current power control parameter of the electronic device at least based on the first-type operation data and the response information, the processor is further configured to:
determine a matching first operation mode of the electronic device based on the first-type operation data;
determine adjustment information at least based on the response information, the adjustment information indicating whether the power control parameter of the electronic device need to be increased;
determine a matching second operation mode of the electronic device based on the first operation mode and the adjustment information; and
acquire the power control parameter corresponding to the second operation mode, and determine the power control parameter corresponding to the second operation mode to be the current power control parameter of the electronic device, different operation modes corresponding to different power control parameters.

11. The electronic device according to claim 8, wherein when adjusting the power control parameter of the electronic device at least based on the first-type operation data and the response information, the processor is further configured to:
determine the first operation mode of the electronic device based on the first-type operation data, each operation mode corresponding to multiple sets of power control parameters, and different operation mode corresponding to at least one set of different power control parameters;
determine adjustment information at least based on the response information, the adjustment information indicating whether the power control parameter of the electronic device need to be increased; and
based on the adjustment information, determine a set of power control parameters among the multiple sets of power control parameters as the current power control parameter of the electronic device.

12. The electronic device according to claim 10, wherein when determining the adjustment information at least based on the response information, the processor is further configured to:
acquire second-type operation data of the at least one target component; and
based on the second-type operation data and the response information, determine the adjustment information.

13. The electronic device according to claim 11, wherein when determining the set of power control parameters among the multiple sets of power control parameters as the current power control parameter of the electronic device based on the adjustment information, the processor is further configured to:
if the adjustment information indicates that there is no need to increase the power control parameters of a processor, determine the first power control parameter among the multiple sets of non-reference power control parameters corresponding to the first operation mode as the current power control parameter of the electronic device;
if the adjustment information indicates that the power control parameters of the processor need to be increased, determine the second power control parameter among the multiple sets of non-reference power control parameters corresponding to the first operation mode as the current power control parameter of the electronic device;
wherein a maximum operating power consumption of the electronic device under the first power control parameter is smaller than a maximum operating power consumption of the electronic device under the reference power control parameter, and a maximum operating power consumption of the electronic device under the second power control parameter is greater than the maximum operating power consumption of the electronic device under the reference power control parameter.

14. The electronic device according to claim 10, wherein the processor is further configured to:
control the operating power consumption of the electronic device based on the power control parameter corresponding to the second operation mode; and
if it is determined within a target duration that the operation mode of the electronic device is the first operation mode based on the first-type operation data of the at least one target component, adjust the power control parameter of the electronic device to the power control parameter corresponding to the first operation mode;
wherein processing performance of the electronic device in the second operation mode is better than processing performance of the electronic device in the first operation mode.

15. A non-transitory computer-readable storage medium storing a computer program, when being executed by one or more processors, the computer program causing the processors to:
acquire first-type operation data of at least one target component in an electronic device, and response information of the electronic device to an interactive operation; and
adjust a power control parameter of the electronic device at least based on the first-type operation data and the response information, the power control parameter being used to control operating power consumption of the electronic device.

16. The non-transitory computer-readable storage medium according to claim 15, wherein when adjusting the power control parameter of the electronic device at least based on the first-type operation data and the response information, the processor is further configured to:
at least based on the first-type operation data and the response information, determine a matching operation mode of the electronic device, and obtain the power control parameter corresponding to the operation mode as a current power control parameter of the electronic device.

17. The non-transitory computer-readable storage medium according to claim 16, wherein when determining the matching operation mode of the electronic device, and obtaining the power control parameter corresponding to the operation mode as the current power control parameter of the electronic device at least based on the first-type operation data and the response information, the processor is further configured to:
determine a matching first operation mode of the electronic device based on the first-type operation data;
determine adjustment information at least based on the response information, the adjustment information indicating whether the power control parameter of the electronic device need to be increased;
determine a matching second operation mode of the electronic device based on the first operation mode and the adjustment information; and
acquire the power control parameter corresponding to the second operation mode, and determine the power control parameter corresponding to the second operation mode to be the current power control parameter of the electronic device, different operation modes corresponding to different power control parameters.

18. The non-transitory computer-readable storage medium according to claim 15, wherein when adjusting the power control parameter of the electronic device at least based on the first-type operation data and the response information, the processor is further configured to:
determine the first operation mode of the electronic device based on the first-type operation data, each operation mode corresponding to multiple sets of power control parameters, and different operation mode corresponding to at least one set of different power control parameters;
determine adjustment information at least based on the response information, the adjustment information indicating whether the power control parameter of the electronic device need to be increased; and
based on the adjustment information, determine a set of power control parameters among the multiple sets of power control parameters as the current power control parameter of the electronic device.

19. The non-transitory computer-readable storage medium according to claim 17, wherein when determining the adjustment information at least based on the response information, the processor is further configured to:
acquire second-type operation data of the at least one target component; and
based on the second-type operation data and the response information, determine the adjustment information.

20. The non-transitory computer-readable storage medium according to claim 18, wherein when determining the set of power control parameters among the multiple sets of power control parameters as the current power control parameter of the electronic device based on the adjustment information, the processor is further configured to:
if the adjustment information indicates that there is no need to increase the power control parameters of a processor, determine the first power control parameter among the multiple sets of non-reference power control parameters corresponding to the first operation mode as the current power control parameter of the electronic device;
if the adjustment information indicates that the power control parameters of the processor need to be increased, determine the second power control parameter among the multiple sets of non-reference power control parameters corresponding to the first operation mode as the current power control parameter of the electronic device;
wherein a maximum operating power consumption of the electronic device under the first power control parameter is smaller than a maximum operating power consumption of the electronic device under the reference power control parameter, and a maximum operating power consumption of the electronic device under the second power control parameter is greater than the maximum operating power consumption of the electronic device under the reference power control parameter.
